(19) United States
(12) Patent Application Publication
(10) Pub. No.: US 2006/0242169 A1
(43) Pub. Date: Oct. 26, 2006

(54) Storing and indexing hierarchical data spatially

(75) Inventor: Brian R. Tunning, San Francisco, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/113,889

(22) Filed: Apr. 25, 2005

(51) Int. Cl. G06F 7/00

(52) U.S. Cl. 707/100

(57) ABSTRACT

Hierarchical data is stored spatially. A flat table may be used to store hierarchical data such that the data's hierarchical organization can be maintained by sorting two integer fields. The data may be positioned in a spatial tree by depth and range. Superior data fields are positioned at higher depths and subordinate fields are positioned at lower depths, depending on their dependencies.

### BACKGROUND OF THE INVENTION

1. Field of the Invention

The present invention is directed to managing and accessing hierarchical data.

2. Description of the Related Art

Hierarchical data, such as data within an XML file, contains two or more nodes having a relationship between them. Typically, the relationship is between a child node and a parent node. A child node is considered to be encompassed or otherwise contained within a parent node.

An example of an XML file 100 having hierarchical data is illustrated in FIG. 1A. XML file 100 contains hierarchical data regarding the context in which a web service is provided. The context data indicates where a web service is available and what features are included in the web service. For example, the root node “Root” contains child nodes “English” and “Spanish” indicating what languages the web service is provided in. The “English” node contains child nodes of “US” and “Canada” indicating in which countries the web service is provided in English. The node “Canada” contains a child node “Bell Canada” indicating a company that provides the web service in English within Canada. The node “Spanish” includes child nodes “US” and “Mexico” indicating in which countries the web service is provided in Spanish. Both the “US” node and “Mexico” node include a “free” node and a “pay” node. The “free” node indicates a basic level of service from the web service and “pay” node indicates a premium level of service from the web service.

FIG. 1B is an example of hierarchical data 150 in a parent-child structure. The hierarchical data 150 of FIG. 1B has the nodes of XML file 100 of FIG. 1A organized in a parent-child relationship. Each node in hierarchical data 150 is associated with a node identification number (Node ID). The Node ID is shown in parenthesis next to each node. Root node (1) is the root node for the hierarchical data set. Nodes English (2) and Spanish (6) are both child nodes of root node (1). Nodes US (3) and Canada (4) are child nodes of node English (2). Node Bell Canada (5) is a child node of node Canada (4). Nodes US (7) and Mexico (10) are child nodes of node Spanish (6). Nodes Free (8) and Pay (9) are child nodes of the node US (7). Nodes Free (11) and Pay (12) are child nodes of node Mexico (10).

FIG. 2 illustrates a table 200 consisting of the hierarchical data 150 of FIG. 1B. Table 200 includes columns having headings of “Name,” “Node ID,” and “Parent Node ID.” The “Name” column lists the names of the nodes within hierarchical data 150. The “Node ID” column lists the node ID for each node listed in the table. As mentioned above, the Node ID is the number in parenthesis for each node in FIG. 1B. The “Parent Node ID” column identifies the Node ID for the parent node of each node listed. For example, the “root” node is listed as the first node in table 200. The “root” node has a node ID of “1” and a parent node ID of “null”. The “Canada” node, the fourth node listed in the table, has a node ID of 4 and a parent node ID of 2, corresponding to its parent node “English.”

Parent-child data structures having a hierarchical relationship such as that of FIGS. 1A-2 are not practical for adding and searching for nodes. To add data to and search a parent-child structure, a recursive search is required of the data within table 200. The recursive search begins with searching the table for the root node of the data structure. The root node is the node that has no parents in the parent-child structure. Each node having the root node as a parent is then determined. For table 200, this determination is made by determining all nodes with a Parent ID of “1”. Next, nodes whose parent node is a child of the root node (the node(s) determined in the previous step) are determined. For example, in hierarchical data 150 of FIG. 1B, the nodes having a parent node of English (2) would be determined. This process continues until all nodes are mapped into the parent-child structure or the desired node and its path to the root node are determined.

A search of the data in table 200 must be performed for each node to determine all children of the particular node. Performing a search for each node to determine the parent-child structure from hierarchical data becomes extremely complex for a large number of nodes. This manner of searching is not practical for more than 1000-2000 rows of data in a table, a relatively small number of nodes for many databases and XML files.

### SUMMARY OF THE INVENTION

The technology described herein relates to storing and indexing hierarchical data spatially. In one embodiment, hierarchical data is stored spatially in a flat table such that hierarchical organization of the data can be maintained by sorting two or more integer fields. A spatial tree is created to represent the hierarchical data using a range over a number line. Within the spatial tree, data may be positioned by depth and range. Superior data fields are positioned at higher depths and subordinate fields are positioned at lower depths, depending on their dependencies. Data is conceptually positioned along an axis by range such that it is contained within the range of its parent field. This spatial representation can be converted into a table by capturing the depth and range information for each data field.

In one embodiment, a method for storing data begins with accessing two or more data elements having a hierarchical relationship. Each data element is then associated with spatial data. The spatial data is then stored in a memory device.

In another embodiment, a method for accessing data begins with receiving a query. The query may include a desired range parameter. One or more sets of hierarchical data having a flat data structure are then accessed. A matching set of hierarchical data corresponding to the query is then determined.

In yet another embodiment, a computer readable medium having a data structure stored thereon may include a first spatial data and a second spatial data. The first and second spatial data contain a first node and second node, respectively. The first and second nodes have a hierarchical relationship. The first and second spatial data are derived from the hierarchical relationship.

### BRIEF DESCRIPTION OF THE DRAWINGS

FIG. 1A illustrates an example of an XML file having hierarchical data.

FIG. 1B illustrates an example of hierarchical data having a child-parent structure.

FIG. 2 illustrates a table of hierarchical data having a child-parent structure.

FIG. 3A illustrates a system for managing a spatial representation of hierarchical data.

FIG. 3B illustrates a computing environment for use with the present invention.

FIG. 4 illustrates a spatial representation of hierarchical data.

FIG. 5 illustrates a table storing the spatial relationship of hierarchical data.

FIG. 6 illustrates a method for retrieving spatial data having a hierarchical relationship.

FIG. 7A illustrates hierarchical data in a spatial structure.

FIG. 7B illustrates a result set generated in response to a query.

FIG. 8 illustrates a method for generating spatial data from hierarchical data.

FIGS. 9A-9F illustrate the addition and modification of nodes in a spatial representation of hierarchical data.

FIGS. 10A-10F illustrate the addition and modification of spatial data in a table.

### DETAILED DESCRIPTION

The technology described herein pertains to storing hierarchical data spatially. The data is stored spatially in a flat table such that hierarchical organization of the data can be maintained by sorting two or more integer fields. For example, the two or more integer fields may include range and depth data. A spatial tree is created to represent the hierarchical data. Data may be positioned by depth and range in the spatial tree. Superior data fields are positioned at higher depths and subordinate fields are positioned at lower depths, depending on their dependencies. Data is conceptually positioned by range along an axis using positive and negative ranges of a number line such that it is contained within the range of its parent field. This spatial representation can be converted into a table by capturing the depth information and range information for each data field.

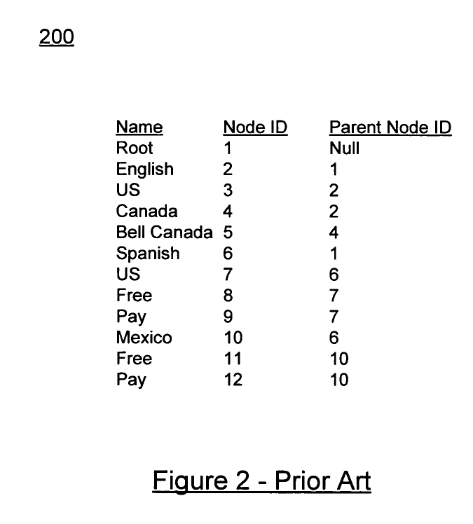

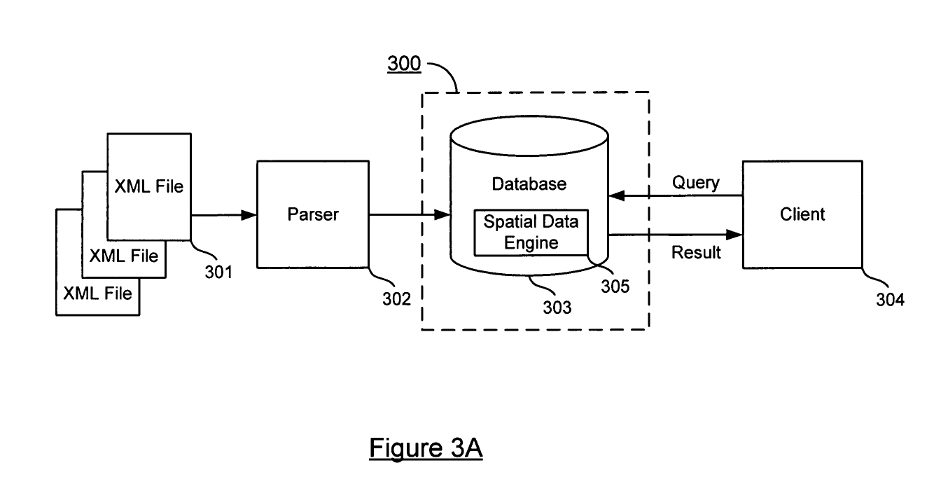

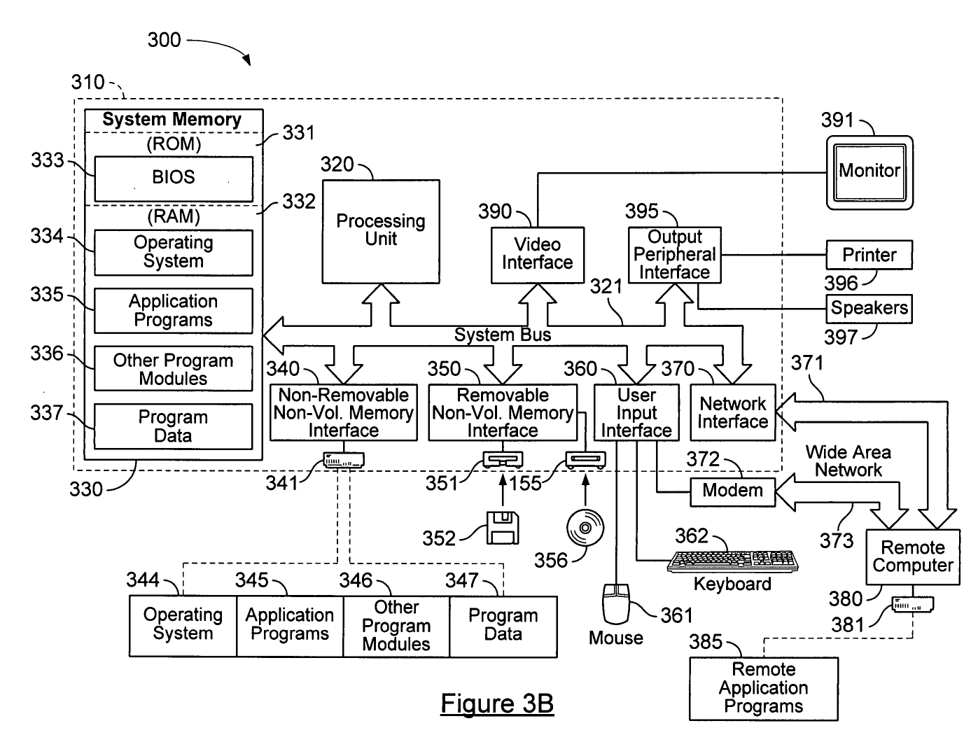

FIG. 3A illustrates one embodiment of a system 300 for managing a spatial representation of hierarchical data. System 300 includes database 303 and spatial data engine (SDE) 305. SDE 305 may be implemented within or separate from database 303. Database 303 may store hierarchical data and other related information in a flat table, such as a spatial representation of the hierarchical data. In one embodiment, database 303 can be deployed as a structured query language (SQL) server. The SQL server can respond to queries formatted in SQL from client machines and other computing systems.

In the embodiment of FIG. 3A, SDE 305 processes queries made to and generates spatial representations of hierarchical data. SDE 305 may generate spatial representations of hierarchical data from data received from parser 302. Parser 302 may receive and parse one or more XML files 301. In some embodiments, parser 302 can be used to parse other formats or types of hierarchical data as well. Parser 302 parses XML files 301 to determine the nodes within each file. Once parsed, parser 302 provides node data to SDE 305. In one embodiment, the node data may include parent node identification information, the name of the node and the name of the XML file from which the node came from. In one embodiment, SDE 305 provides node identification data to parser 302 in response to receiving node data for a new node. The node identification information received by parser 302 can be used to provide the parent node ID information for subsequent node data transmissions. Generation of a spatial representation of hierarchical data is discussed in more detail below.

SDE 305 may be queried for hierarchical data by client 304. Client 304 may be any computing device capable of sending and receiving information. The query may include a node name, spatial representation information, or other information. In response to the query, SDE 305 generates and transmits a result to client 304. Searching a spatial representation of hierarchical data in response to a query is discussed in more detail below.

FIG. 3B illustrates an example of a suitable computing system environment 308 in which system 300, parser 302 and/or client 304 of FIG. 3A may be implemented. The computing system environment 308 is only one example of a suitable computing environment and is not intended to suggest any limitation as to the scope of use or functionality of the invention. Neither should the computing environment 308 be interpreted as having any dependency or requirement relating to any one or combination of components illustrated in the exemplary operating environment 308.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the invention includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through an non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 20 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through a output peripheral interface 390.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

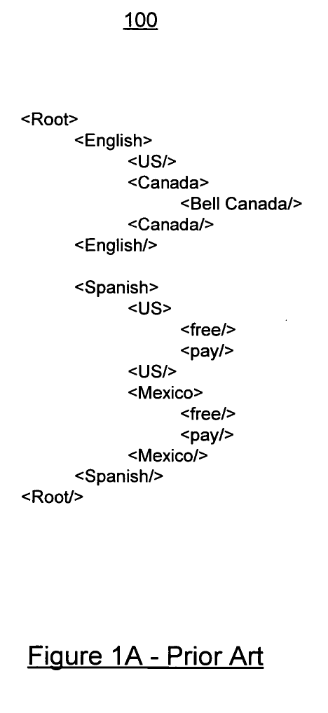

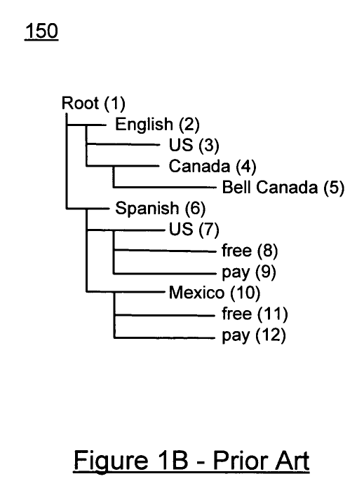

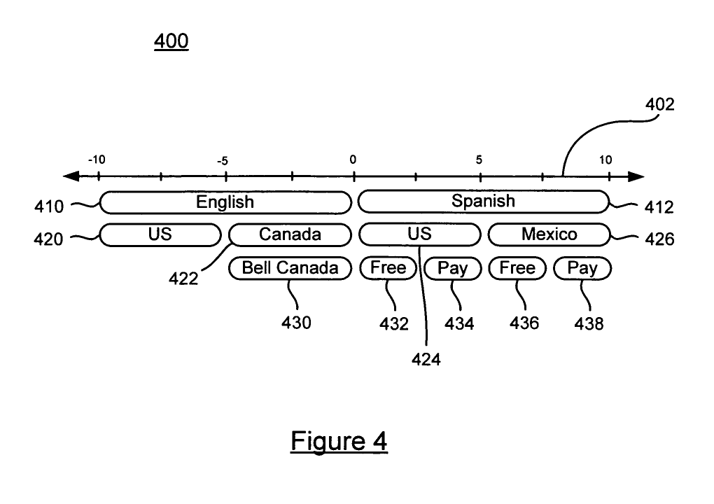

FIG. 4 illustrates an example of a spatial representation of hierarchical data 400 which can be managed by system 300 of FIG. 3A. Hierarchical data 400 contains the same nodes as the hierarchical data depicted in FIGS. 1A-2, but the data is organized spatially. Each node of the hierarchical data is associated with a container having a conceptual spatial position. The spatial position of a container indicates the container's relationship with other containers. Because the spatial position indicates a relationship, no explicit parent-child relationship information is needed. Each container's spatial position in the spatial representation is described by a range and depth parameter. In the embodiment illustrated in FIG. 4, the range is expressed as a numerical range along range line 402. Objects having a range that lies within the range of another container positioned at a higher depth are considered contained by or included in that object. For example, container Mexico 426 has a range of 5 to 10 which is located within the range of but at a depth below node Spanish 412. Mexico 426 is therefore contained by node Spanish 412.

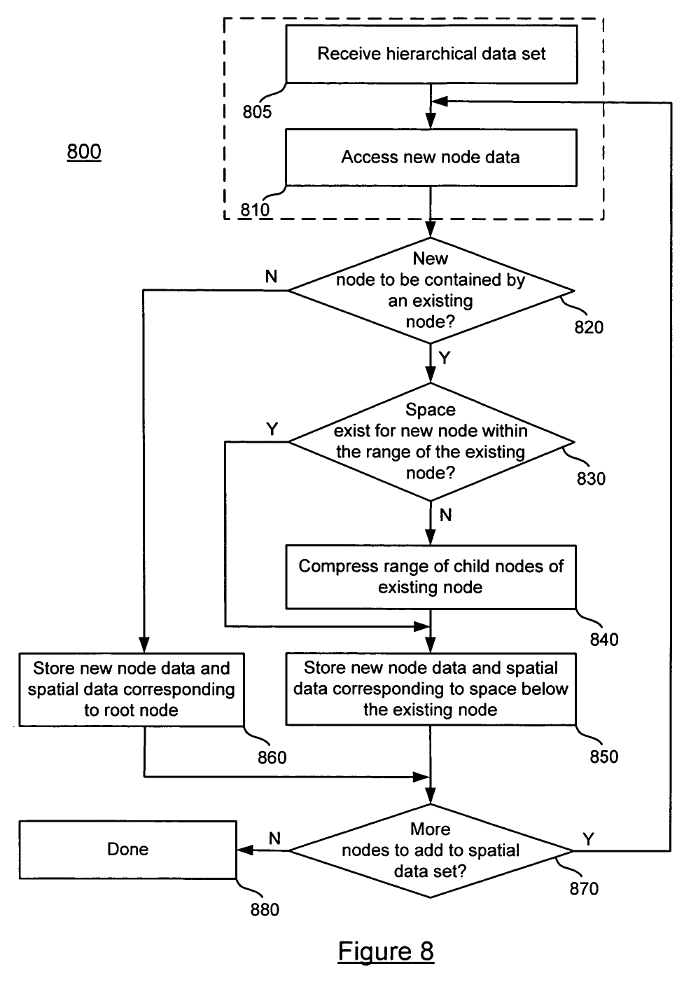

A range line for representing spatial data, such as range line 402, can be generated by system 300 when spatial data is generated from hierarchical data. Generation of spatial data from hierarchical data is discussed in more detail below with respect to FIG. 8. Generation of a range line involves determining the end points of the range. The end points may be integers, rational numbers, or some other number. Either range end point can be a positive or negative number. A range line may have containers positioned at different intervals. The range line intervals at which containers are positioned may be integers, rational numbers, or some other number. In one embodiment, one end point may be positive and the other end point may be negative. For discussion purposes, end points of −10 and 10 will be used in the examples herein. However, this example range line is not intended to limit the scope of the invention, and other endpoint values can be used as well

In one embodiment, a container may contain an object, a logical block or another container. For example, a container may contain a video file, an audio file, a sub-routine, a set of processor instructions, a digital image, or some other object. In one embodiment, a container may hold any logical block that may be included in an XML file.

Hierarchical data 400 of FIG. 4 is represented in a spatial structure that includes containers 410, 412, 420, 422, 424, 426, 430, 432, 434, 436, and 438. Containers 410 and 412 have a depth of “1”. Container 410, having a node named “English”, has a range of −10 to 0. Container 412, having a node named “Spanish”, has a range of 0 to 10. Containers 420 and 422 have a depth of “2”, one depth level below container 410. Container 420, containing a node called “US”, has a range of −10 to −5 and container 422, containing a node called “Canada”, has a range of −5 to 0. The depth of containers 420 and 422 are one level below and within the range of container 410, indicating that containers 420 and 422 are contained within container 410. Container 430, having a node named “Bell Canada”, has a depth level of “3” and a range of −5 to 0. Container 430 is contained by container 422 because it is one depth level lower and within the range of container 422.

Containers 424 and 426 contain nodes with names “US” and “Mexico”, respectively. Similar to containers 420 and 422, containers 424 and 426 are positioned at a depth level of “2”. Container 424 has a range of 0 to 5 and container 426 has a range of 5 to 10. Container 412 contains containers 424 and 426 because it is positioned one level above and encompasses the range of containers 424 and 426.

Containers 432, 434, 436 and 438 are positioned at level “3”. Container 432 has a range of 0 to 2.5 and a node named “Free”. Container 434 has a range of 2.5 to 5 and a node named “Pay”. Containers 432 and 434 are within the range of and contained by container 424. Containers 436 and 438 have ranges of 5 to 7.5 and 7.5 to 10 and names of “Free” and “Pay”, respectively. Container 426 includes containers 436 and 438.

FIG. 5 illustrates a table 500 derived from the structure of FIG. 4. Table 500 includes four columns having headings of “Name,” “x1”, “x2”, and “Depth.” The “Name” column indicates the name of the node within the container. The “x1” and “x2” columns contain values representing the range of the particular container with reference to range line 402 of FIG. 4. In some embodiments, the range may be represented as a beginning point and an end point of the range. In some embodiments, the range may be represented as a single point and a length from or about the single point. The “Depth” column indicates the depth level at which each container is spatially positioned within spatial structure 400. Table 500 also includes an optional column having a heading of “Container”, which lists the corresponding container reference numbers from FIG. 4 for each node. This column is included for discussion purposes, and need not be included in a table of hierarchical data.

Each of containers 410-438 of hierarchical data 400 of FIG. 4 is listed in table 500. For example, container 410 is listed in the first row of table 500 and has a node name “English,” x1 value of “−10,” x2 value of “0”, and depth of “1.” Container 422 has a node named “Canada”, an x1 value of “−5”, an x2 value of “0”, and a depth of “2”. Container 430 has a node named “Bell Canada”, an x1 and x2 value of “−5” and “0”, respectively, and a depth of “3”. Container 438 has a node named “Pay”, an x1 value of “7.5”, an x2 value of “10” and a depth of “3”.

In one embodiment, a table containing hierarchical data comprising a spatial structure may include a unique clustered index on range data and depth data. A unique clustered index is an index or pointer indicating where on a disk drive (or other storage device) the particular data exists. Thus, a unique clustered index is a map to the physical location of data on a hard drive or other storage device. Use of a unique clustered index allows a database or other system in which the data is stored to maintain the entire data file in order. As a result of keeping the data file in order, records can be inserted and read more quickly.

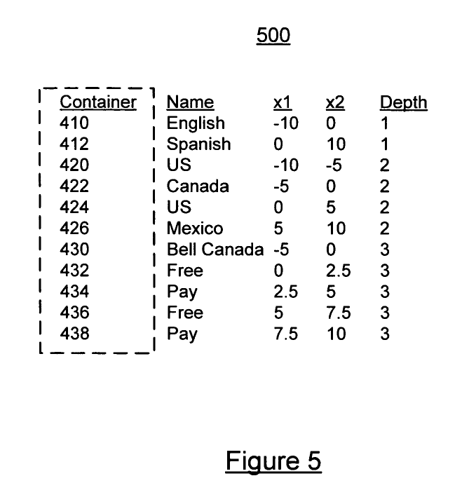

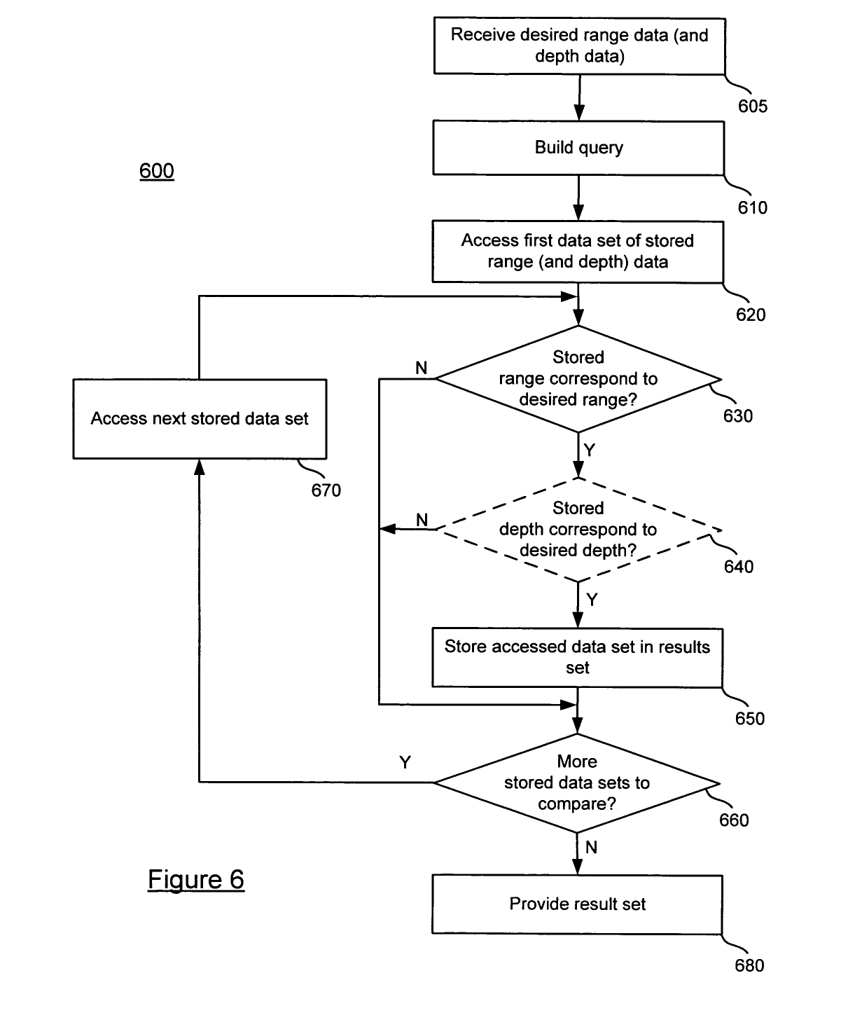

FIG. 6 is a flowchart describing one embodiment of a method for querying spatial data that has a hierarchical relationship. For example, the method of FIG. 6 can be used to search the table of FIG. 5. In one embodiment, method 600 is performed by spatial data engine 305 of system 300. Desired range data is received at step 605. Optionally, desired depth data may also be received at step 605. In one embodiment, the desired data is received by receiving input from a user. The input may include either range data, depth data, or both. For example, for hierarchical data 400 of FIG. 4, the received range data may specify a range along range line 402 or a single point along range line 402. The received depth data, if any, could be “3”, “2”, “1” or not specified. If specified, the search for data will encompass data having a depth up to the specified depth level. In one embodiment, if the depth is not specified, the result set may include the container at the lowest depth that matches the received range data.

In an embodiment where a user initiates the query of step 605, the user may provide the range data directly or indirectly to system 300 of FIG. 3. If the desired range data is already known to the user, the user may provide the range data in the query. If the desired range data is not already known, the user may query the spatial data for node information such as the desired node or a node related to the desired node by element name, node ID, or some other field. Upon receiving node information, system 300 will return spatial data associated with the desired node, including the range of the desired node. For example, a user may submit a query for all descendants of a node having a particular node ID or siblings of a particular node (when a user knows a relationship of the desired node to other nodes, but not the node itself). In response to this query, system 300 will return node information, including spatial data information, to all nodes that match the query parameters.

A query is built at step 610. The query is built from the range data and/or depth data received at step 605. In one embodiment, the query is built by determining a point within the range data. The determined point is subsequently used for comparison against stored range data. For example, for a query having a desired range data of −5 to 0, the point within the access range could be the middle of the range, or −2.5. In some embodiments, the received range itself is used.

In one embodiment, when used with an SQL server, the query may be generated by a processor or other query engine within the SQL server in response to receiving a search statement from a user. An example of the search statement is below:

Select * from segment where −2.5 between x1 and x2 order by depth

Desc

The search statement above beginning with “Select” generates a query for containers within a spatial structure having a range that includes the point “2.5”. The containers are to be ordered by depth. The “Desc” statement indicates that the containers that match the query should be sorted in descending order. The search statement illustrates an embodiment wherein only the range of a container is specified. As discussed above, the search having only range information will generate a data set having all containers which include the point or range information specified.

A first set of stored range and depth data is accessed at step 620. The first set of stored range and depth data may be the first set or row of hierarchical data within a table or other data stored in memory. For example, for a search of table 500 of FIG. 5, the first data set accessed would be the first row of data associated with container 410. A determination is then made as to whether the stored range corresponds to the desired range at step 630. A processor or some other data comparison engine may determine whether the desired and stored data correspond. In one embodiment, the determination involves whether or not the desired range point or the desired range lie within the stored range. For example, the first accessed data set associated with container 410 of FIG. 4 has range data of −10 to 0. A desired range of −5 to 0, or a desired range point of −2.5, lies within the range of container 410. In a comparison between this desired range and the range of the accessed data set of container 410, the range of the dataset would correspond to the desired range. If the stored range corresponds to the desired range, operation continues to step 640 if a desired depth range was received at step 605. If no desired depth range was received, operation continues at step 650. If the stored range does not correspond to the desired range, then the accessed set of data is not used and may be ignored. Operation then continues from step 630 to step 660.

If a desired depth is received at step 605, the depth parameter of the accessed data set is analyzed at step 640. In one embodiment, a determination is made as to whether the depth of the stored data corresponds to the depth of the desired data at step 640. In one embodiment, the depth of the stored data and desired data correspond to each other if they match. In some embodiments, the depth of the stored data and desired data correspond to each other if the stored depth level is equal to or lower than the desired level. For example, the first accessed data set in table 500 corresponding to container 410 has a depth of “1”. In this case, if the desired depth was 1 or lower, container 410 would meet this criteria. A data set having a depth level of “3” would match a desired data depth level of “1”, “2” or “3”. A stored data depth level of “1” would not match desired depth levels of “2” or “3”. If the stored depth data corresponds to the desired depth data, operation continues to step 650. If the stored depth data does not correspond to the desired depth data, operation continues to step 660. The accessed data set is stored in a result set at step 650. In one embodiment, the result set is stored in memory, such as local memory of the computing environment processing the stored data.

A determination is made as to whether more stored data sets exist to be processed at step 660. In one embodiment, another data set to be processed may be another row of data in a table such as table 500 of FIG. 5. If more data sets exist to be processed, operation continues at step 670 where the next stored data set is accessed. Operation then continues at step 630. If no further data sets exist to be processed, then operation continues at step 680 wherein a result set is provided. The result set may be provided in the form of a table or some other format to a requesting entity, such as a user or requesting machine.

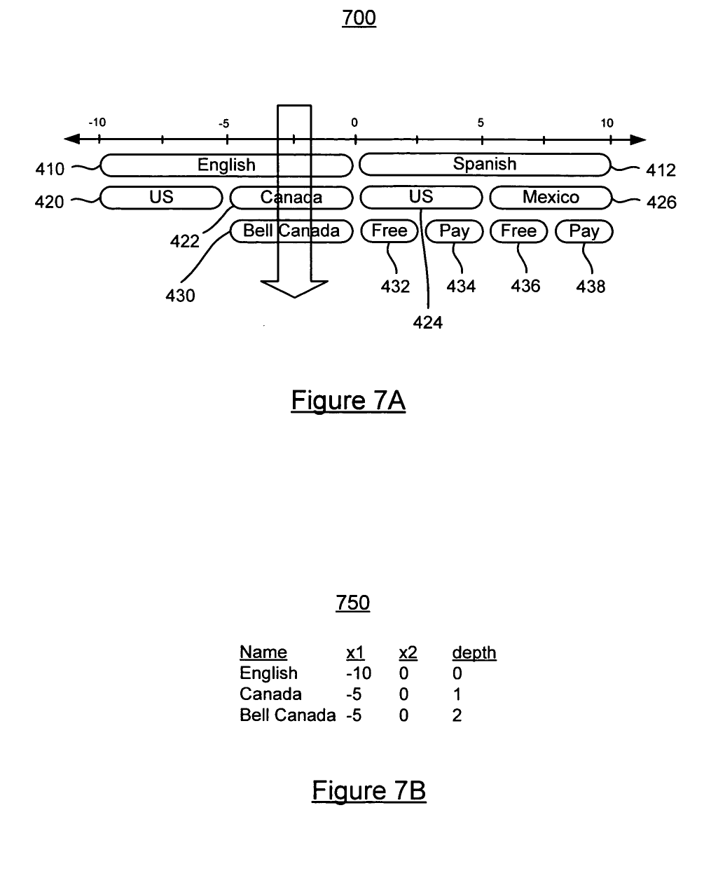

FIG. 7A illustrates a spatial representation of hierarchical data 700. Hierarchical data 700 is the same hierarchical data 400 illustrated in FIG. 4. In one embodiment, the result set provided at step 680 of method 600 provides results ordered by depth. The depth order of the data set may be specified in a request by the user or entity requesting the data set. For example, for a search of containers within hierarchical data 700 between a range of −5 to 0 in descending order, the result set would include containers overlapped and in the order indicated by arrow 710. Arrow 710 indicates a visualization of a result set path in the spatial representation of hierarchical data 700. In particular, the result set would include a data path as follows:

English/Canada/Bell Canada

FIG. 7B is an illustration of a result set in table format. The result set corresponds to the result set discussed above with respect to FIG. 7A and can be generated by a system 300 of FIG. 3 performing method 600. The result set 750 corresponds to the data over which arrow 710 is positioned in FIG. 7A. Table 750 includes data associated with containers having the name “English,” “Canada,” and “Bell Canada.” English has a range of −10 to 0 and a depth of 0. Canada has a range of −5 to 0 and depth of 1. Bell Canada has a range of −5 to 0 and a depth of 2. The range of the containers listed in table 750 includes the desired range of −5 to 0, or a point of −2.5, as discussed above in the examples and with reference to the example “Select” statement.

FIG. 8 illustrates a method 800 for generating spatial data from hierarchical data. The hierarchical data can be data from a table, an XML file, or other data. For example, method 800 can be used to generate table 500 of FIG. 5 from the hierarchical data of FIG. 1A, 1B or 2. In one embodiment, method 800 may be performed by parser 302 and/or spatial data engine 305 of FIG. 3. An example of a pseudo-XML file having hierarchical data which will be used as an example in the discussion of FIGS. 8-10 is below.

```
<root>
    <A/>
    <B/>
    <C/>
    <D/>
    <E/>
<root>
```

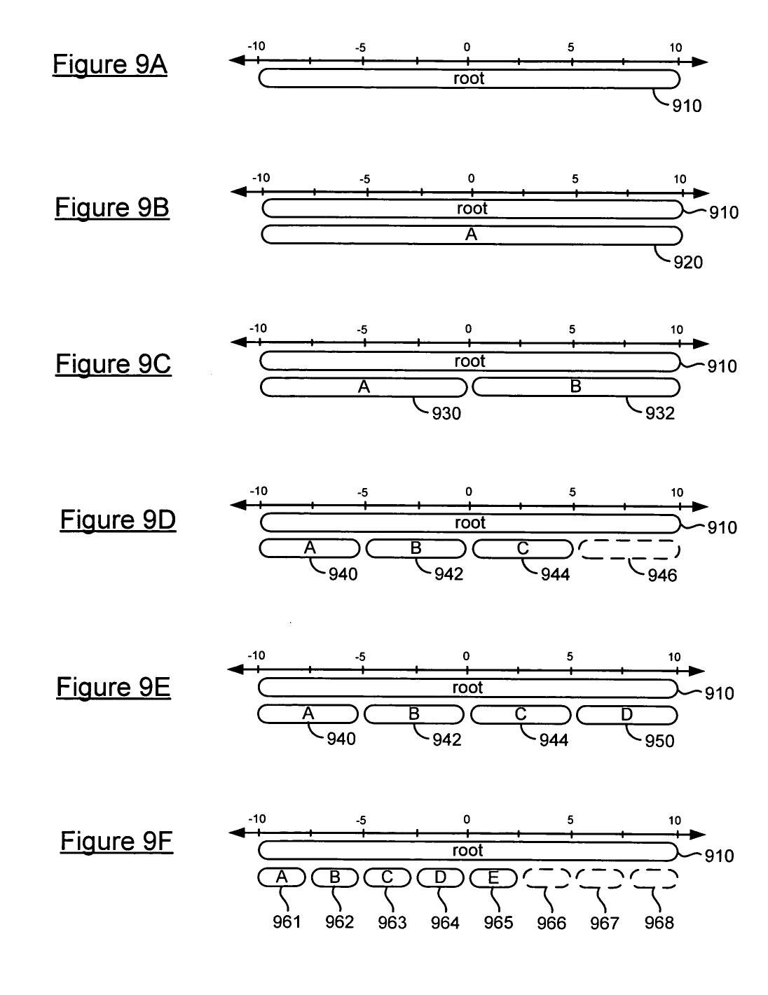

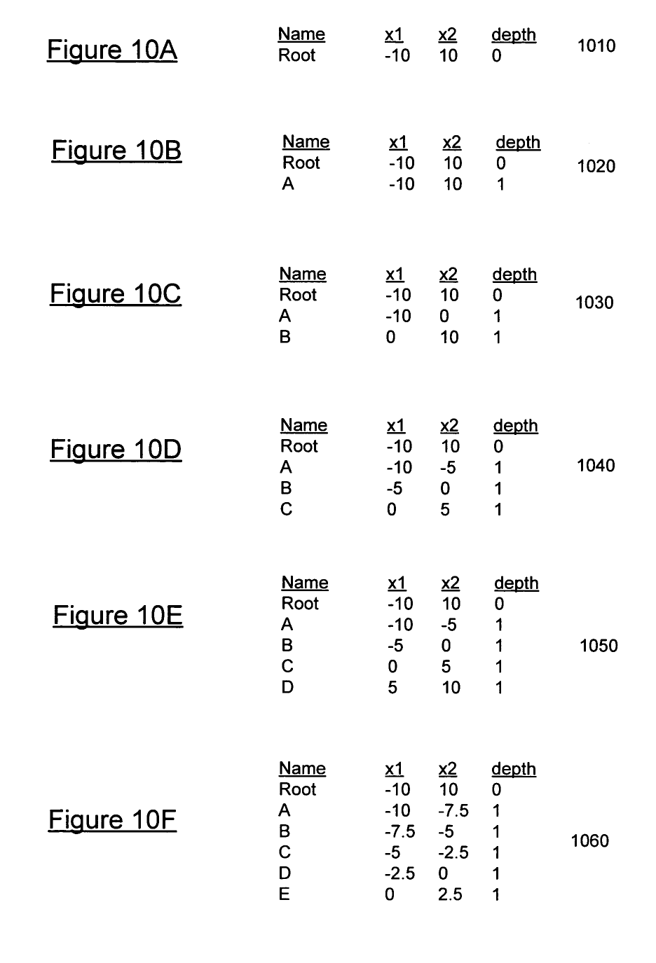

The pseudo XML file above has a root node named “root” and five child nodes to the root node named “A”, “B”, “C”, “D” and “E”. Method 800 will be discussed with reference to corresponding spatial representations of data illustrated in FIGS. 9A-F and tables of spatial data in FIGS. 10A-F. FIGS. 9A-9F illustrate hierarchical data having a spatial structure. Each of FIGS. 9A-E illustrates an addition of a container to the spatial representation of hierarchical data. As new nodes of data are added, the spatial representation changes in each figure. FIGS. 10A-F illustrate the spatial data of the spatial representations of FIGS. 9A-F in table format.

In method 800, hierarchical data is received at step 805. The hierarchical data may include several data sets associated with nodes of data. The received data may be retrieved locally from memory or received from an outside source, such as parser 302 of FIG. 3A. A new node of data is then accessed from the received hierarchical data at step 810. Accessing the first node data may include accessing a first data set or row of data in a table, a first object in a file, or a first node in some other set of hierarchical data. In one embodiment, the node data may include parent node identification data, name data, and file name data in which the node is contained.

In one embodiment, new nodes of data are received individually. In this case, steps 805 and 810 are combined into a single step. For example, with reference to FIG. 3A, parser 302 may receive and parse one or XML files 301. Parser 302 may then transmit individual nodes of data from an XML file to system 300. The individual nodes of data may be received and processed by SDE 305. In one embodiment, when an individual node is received by SDE 305, the node is assigned a node identifier. The node identifier is then provided to the source of the node data.

In steps 820-860, each data element, or node of data, is associated with spatial data. A determination is made as to whether the new node of data should be contained by an existing node at step 820. In one embodiment, if a range line does not already exist, a range line is generated. A new node should be contained by an existing node if it is a child of an existing node in the hierarchical data set received at step 805. In one embodiment, the new node should be contained by an existing node if the new node data includes parent node identification data. For example, if the new node data is node “A” from the above example and has parent node ID data of existing node “root”, then the new node should be contained by the existing “root” node. If the new node should be contained by an existing node, operation continues at step 830. If the new node should not be contained by an existing node, then operation continues at step 860.

At step 860, the new node data and spatial data corresponding to the root node is stored. The new node data stored at step 860 is a root node. Accordingly, the spatial data corresponding to the new node data is assigned the maximum range possible and the highest depth possible. An example of a spatial representation of a new root node 910 named “root” is illustrated in FIG. 9A. The root node 910 has a depth of 0 and a range of −10 to 10, spanning the entire length of the range line. The new node, range and depth data are then stored at the top of the spatial data set (for example, a table) as a root node. For example, data associated with root node 910 which is stored at step 860 of method 800 is stored in table 1010 of FIG. 10A. The root node data of table 1010 includes a name of “Root”, x1 value of “−10” and x2 value of “10” corresponding to the range values of the spatial representation of the data in FIG. 9A, and a depth of “0”. Operation then continues at step 870.

A determination is made as to whether space exists for the new node to be contained by the existing node within the spatial representation of the hierarchical data at step 830. The existing node is the node in which the new node is determined to be contained in at step 820. A space exists if there is a vacant conceptual spatial position within the range of the existing node at the next lowest depth within the conceptual spatial representation of the hierarchical data. For example, the spatial representation of root node 910 in FIG. 9A shows no nodes currently contained by root node 910 in FIG. 9A. If a new node, node A from the pseudo XML file above, is to be contained by root node 910, the determination would be made that space exists for node A to be contained by root node 910. Similarly, if a new node was to be added to the spatial representations of FIG. 9D or 9F, the determination would be made that a space is available for the new node. In FIG. 9D, conceptual space 946 exists for addition of a new node. In FIG. 9F, conceptual spaces 966-968 exist for the addition of a new node. In one embodiment, a node would be inserted in the space having the smallest numerical range value of multiple available spaces. In FIG. 9F, this corresponds to space 966. If a space does exist for a new node within the existing node, operation continues to step 850.

If space does not exist for the new node within the existing node, operation continues to step 840. For example, in the spatial representation of the hierarchical data of FIG. 9C, a conceptual space does not exist for the node “C” to be added. Similarly, a conceptual space does not exist for further nodes in the spatial representation of FIG. 9E. In these cases, if a new child node was to be added to the root node 910, operation would continue at step 840.

The range of the child nodes of the existing node is compressed at step 840. In one embodiment, the range of child nodes is compressed to one half their previous range. In some embodiments, other compression factors may be used, such as one third, one fourth, or some other value. By compressing child node range values, space is made for additional nodes to be inserted. In some embodiments, when the range data of child nodes of an existing node are compressed, the corresponding child nodes, if any, of the compressed child nodes are compressed as well. The child nodes range data of the child nodes are compressed so that they lie within the range of their parent node.

In the spatial representation of FIG. 9C, the child “A” was compressed from a range of −10 to 10 as illustrated in FIG. 9B to a range of −10 to 0. This corresponds to a compression of one half the child node's previous range. Nodes “A” and “B” of the spatial representation of FIG. 9C were compressed from a range of −10 to 0 and 0 to 10 to ranges of −10 to −5 and −5 to 0 in the spatial representation of FIG. 9D. Similarly, nodes “A”-“D” in the spatial representation of FIG. 9E were compressed to half their range in FIG. 9F. For example, node A was compressed from a range of −10 to −5 in FIG. 9E to a range of −10 to −7.5 in FIG. 9F.

New node data and spatial data corresponding to the space below the existing node are stored at step 850. The node data includes the name assigned to the logical object or other data comprising the node. In one embodiment, the node data also includes parent node identification data as well as file name data in which the node data is contained in. The spatial data is the data associated with the spatial position of the node within a spatial structure such as that of FIG. 4. In particular, the spatial data includes range data and depth data.

Tables 1020-1060 of FIGS. 10B-10F illustrate the storage of node data and spatial data with reference to step 850 of method 800. The tables include node data, the name of the node, and spatial data, the x1, y1 and depth data. Table 1020 of FIG. 10B illustrates data for nodes “Root” and “A” corresponding to the spatial representation of FIG. 9B. Both the root node and A node comprise the entire range line of FIG. 9B, having an x1 range value of “−10” and an x2 range value of “10”. The root node is at a depth level of “0” and the A node is at a depth level of “1”.

Table 1030 of FIG. 10C illustrates node and spatial data for the root node, compressed node A and new node B of the spatial representation of FIG. 9C. The data of compressed node A has a range of −10 to 0. New node B has a range of 0 to 10. Both nodes A and B have a depth of 1.

Table 10D illustrates data which is stored after compression of range data for nodes A and B and the addition of new node C. Node A has range data of −10 to −5, node B has a range of −5 to 0, and new node C has a range of 0 to 5. Nodes A, B and C all have a depth of “1”. Table 10E illustrates the addition of data corresponding to new node D. New node D was positioned in conceptual space 946 of the spatial representation of FIG. 9D, so no new compression was required. The data stored for new node D includes range data of 5 to 10 and a depth of 1.

Table 9F illustrates data stored in table 1060 for the spatial representation of FIG. 9F. The data stored in table 1060 includes range data for nodes A-E compressed to make conceptual room for new node E. The range data for nodes A-D was compressed from a range length of 5 to a range length of 2.5. For example, the range of node A was compressed from a range of −10 to −5 in the spatial representation of FIG. 9E to a range of −10 to −7.5 in the spatial representation of FIG. 9F. The range data for new node E in table 1060 has an x1 value of 0, a x2 value of 2.5 and a depth of “1”

Returning to method 800, after storing the node data and spatial data, a determination is made as to whether more nodes should be added to the spatial data set at step 870. In one embodiment, if the received data set at step 805 includes more data sets (such as more rows in a table), then more nodes of data are to be added to the spatial data set. In some embodiments, if additional node data is received from an outside source, such as parser 302 of FIG. 3, then additional nodes of data should be added to the spatial data set. If no additional nodes are to be added, operation of method 800 is complete at step 880. If more nodes are to be added to the spatial data set at step 870, operation continues at step 810 where the next new node data is accessed.

In one embodiment, the flowchart of FIG. 8 can be performed by an SQL server executing software. An example of suitable software is below.

```
CREATE PROCEDURE dbo.add_node
(
@parent_id int,
@node_name nvarchar(256),
@new_file_id int = 0
)
AS
--setup
set nocount on
--declares
--general
declare @new_id int
declare @min bigint
declare @max bigint
declare @file_id int
set @min = −922337203685477580
set @max = 922337203685477580
--parent
declare @parent_depth int
declare @parent_x bigint
declare @parent_length bigint
declare @parent_x2 bigint
--rightmost child
declare @child_x bigint
declare @child_length bigint
declare @child_x2 bigint
--new
declare @new_x bigint
declare @new_length bigint
--if root
if @parent_id = 0
begin
  set @file_id = @new_file_id
  set @parent_depth = 0
  set @new_x = @min
  set @new_length = @max − @min
  goto write_node
end
--get parent
declare cur_node cursor local fast_forward
for
  select
    file_id,
    x,
    x + length,
    length,
    depth
  from node where id = @parent_id
open cur_node
fetch next from cur_node into @file_id, @parent_x, @parent_x2,
@parent_length, @parent_depth
close cur_node
deallocate cur_node
--locate rightmost child
declare cur_child cursor local fast_forward
for
  select
  top 1
    x,
    length,
    x+length
  from
    node
  where
    file_id = @file_id
    and depth = @parent_depth + 1
    and x >= @parent_x
    and (x + length) <= @parent_x2
  order by
    x desc
open cur_child
fetch next from cur_child into @child_x, @child_length, @child_x2
if @@fetch_status = −1
  begin
    set @new_x = @parent_x
    set @new_length = @parent_length
    goto write_node
  end
close cur_child
deallocate cur_child
--is there space available?
if @parent_x2 − @child_x2 >= @child_length
begin
  --allocate it
  set @new_x = @child_x2
  set @new_length = @child_length
  goto write_node
end
else
begin
  --compress
  set @new_length = @child_length / 2
  --run compression
  update node
  set
  --x = x − (((x − @parent_x)/(length)) * (length/2)),
  x = x − ((x − @parent_x) / 2),
  length = length/2
from
  node
where
  file_id = @file_id
  and depth > @parent_depth
  and x >= @parent_x
  and x + length <= @parent_x2
--figure new position
set @new_x = (@child_x − (((@child_x − @parent_x)/
@child_length) *
@new_length)) + @new_length
end
--commit
write_node:
insert into
  node
  values
  (
    @file_id,
    @new_x,
    @new_length,
    @parent_depth + 1,
    @node_name
  )
  set @new_id = @@identity
  -- return
  return @new_id
  GO
```

The code above first determines if the received node data is a root node. If not, the code then determines the parent node of the received node data. A determination is then made as to whether a conceptual space is available underneath the received node's parent node. If not, the existing child nodes are compressed to generate a conceptual space. The received data node is then inserted into the conceptual space within the spatial representation of the data and the spatial data and node data are stored.

In one embodiment wherein the range data of a container within a spatial representation is stored as a point and a length, calculation of the new x1 value point and length of the container after compression can be calculated as follows:

$$x ( compressed ) = x - \frac{x - {x}_{parent}}{2} , and L ( compressed ) = L / 2 ,$$

where x (compressed) is the x1 coordinate of the container after compression, x is the current left coordinate of the container, xₚₐᵣₑₙₜ is the left coordinate of that container's parent container, L(compressed) is the length of the container after compression and L is the current length of the container. For example, to add a new node C as a sibling of root node container 910 in the spatial representation of FIG. 9C, current sibling nodes A and B must be compressed. The current spatial data for B includes an x1 value of 0 and a length of 10. The x1 value of the B node's parent node, container 910 having the root node, is −10. To determine the new spatial data associated with node B 932 of FIG. 9C after compression, the algorithm can be solved as follows:

$$x ( compressed ) = 0 - \frac{0 - ( - 10 )}{2} = - 5 , and L = 10 / 2 = 5.$$

Thus, a compression of container 932 of FIG. 9C results in a new container that begins at the x1 value of −5 and has a length of 5. This is illustrated in FIG. 9D by container 942. The algorithm above ensures that the containers placed into the data structure efficiently use the available space of the structure. In one embodiment, the container range values may be implemented as 64-bit integers, having a minimum value of −922,337,203,685,477,580 and a maximum value of 922,337,203,685,477,580.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for storing data, comprising:
accessing two or more data elements having a hierarchical relationship;
associating each data element with spatial data; and
storing the spatial data.

2. The method of claim 1, wherein the spatial data has a flat data structure.

3. The method of claim 1, wherein the spatial data is stored in a table having range data and depth data.

4. The method of claim 3, wherein data elements having a sibling relationship have depth data with an equal value.

5. The method of claim 3, wherein a range associated with a child data element is within a range associated with a parent data element of the child data element.

6. The method of claim 3, wherein the depth data associated with a child data element is lower than the depth data associated with the corresponding parent data element.

7. The method of claim 1, wherein the spatial data is generated from the hierarchical relationship between the two or more data elements.

8. The method of claim 1, further comprising:
receiving a request for a data element, the request including desired spatial data; and
providing matching data elements associated with the desired spatial data.

9. The method of claim 8, wherein said step of providing matching data elements includes providing a matching data element having the lowest depth that matches the desired spatial data and parent nodes of the provided matching data element.

10. The method of claim 1, wherein said step of accessing includes accessing an XML file, the two or more data elements are contained in the XML file.

11. The method of claim 1, further comprising:
accessing a new data element having a hierarchical relationship with the two or more data elements;
generating new spatial data associated with the new data element; and
inserting the new spatial data into the stored spatial data.

12. A method for accessing data, comprising:
receiving a query including a desired spatial range parameter;
accessing one or more sets of hierarchical data having a flat data structure, each set of data associated with spatial range data; and
determining a matching set of hierarchical data corresponding to the desired spatial range parameter.

13. The method of claim 12 wherein the flat data structure is in the form of a table.

14. The method of claim 12, wherein said step of determining a matching set of hierarchical data includes:
determining whether the spatial range data of the one or more sets of hierarchical data corresponds to the spatial range parameter of the query.

15. The method of claim 12, wherein each set of hierarchical data is associated with depth data, said step of determining a matching set of hierarchical data including:
determining an order of the matching set of hierarchical data from the depth data.

16. A computer-readable medium having stored thereon a data structure, comprising:
a first spatial data for a first node; and
a second spatial data for a second node, the first node and second node having a hierarchical relationship, said first and second spatial data derived from the hierarchical relationship.

17. The computer-readable medium of claim 17, wherein said first and second spatial data includes coordinate data.

18. The computer-readable medium of claim 17, the spatial data including depth data, wherein data elements having a sibling relationship have a same depth data.

19. The computer-readable medium of claim 17, wherein the coordinate data includes a range, the range associated with a child data element is within a range associated with a parent data element of the child data element.

20. The computer-readable medium of claim 17, wherein the coordinate data includes a depth, the depth associated with a child data element is lower than the depth associated with the corresponding parent data element.
